(19) United States
(12) Patent Application Publication
(10) Pub. No.: US 2009/0271627 A1
(43) Pub. Date: Oct. 29, 2009

(54) Secure Data Transmission

(76) Inventors: Ram Cohen, Tel Aviv (IL); Meir Zorea, Rehovot (IL)

Correspondence Address: Fay Sharpe LLP, 1228 Euclid Avenue, 5th Floor, The Halle Building, Cleveland, OH, 44115, US

(21) Appl. No.: 11/991,527

(22) PCT Filed: Sep. 26, 2006
(86) PCT No.: PCT/IL2006/001122

§ 371 Date: Mar. 4, 2008

Related U.S. Application Data
(60) Provisional application No. 60/596,464, filed on Sep. 26, 2005.

(51) Int. Cl. H04L 9/32

(52) U.S. Cl. 713/171

(57) ABSTRACT

A method of facilitating secure sending of a message from a sender to a recipient over a network, comprising establishing communication between a sender side and a recipient trusted server having knowledge of an encryption key of recipient; obtaining a messaging key comprising a messaging encryption key and a messaging decryption key; exchanging messaging key data between sender side and recipient trusted server such that sender side has knowledge of the messaging encryption key and recipient trusted server has knowledge of the messaging decryption key; encrypting messaging decryption key with recipient's encryption key by recipient trusted server; transmitting messaging decryption key encrypted by recipient's encryption key from recipient trusted server to sender side, and transmitting messaging decryption key encrypted by recipient's encryption key from sender side to recipient and transmitting the message encrypted by messaging encryption key directly from sender side to recipient.

### FIELD OF THE INVENTION

The present invention is directed to providing a method and system for securing data transmission between end user telecommunication equipment over a network, particularly but not exclusively for securing electronic mail over the Internet.

### BACKGROUND OF THE INVENTION

The information age relies heavily on the transfer of data between computers, mobile phones and other telecommunication equipment. Effective and convenient data transfer relies on standardized data formats, such that different users using very different equipment can communicate with each other. To enable accurate data transmission over large distances, data is digitized, text is encoded in ASCII, documents are formatted in rich text format, and other similar standardized systems are used to ensure maximum reproducibility of transmitted data between different users using widely different terminal equipment.

Much data, such as many websites, academic databases and libraries are readily accessible to anyone, and are considered as being in the public domain, albeit some access, particularly commercial use, may require payment, such as copyright royalties, for example. Other data are considered private or confidential, and although controlled, easy, cross-platform transmission to specific parties is desirable, it is nevertheless also desirable to protect such data from prying eyes. This may be because of the data having a personal nature, to protect patient privacy, client-attorney privilege, for commercial reasons or because of issues of national security, for example.

One way to protecting data files, such as e-mails (electronic messages) during transmission, is to use some type of encryption. Encryption is the process of changing text so that it is no longer easy to read. Non-encrypted e-mails have been compared to ‘open books’ or post cards, since they may be read by anyone. With encryption however, only the intended recipient will be able to open and read the message, and many types of encryption are known.

Almost all modern encryption methods rely on a ‘key’, which is a particular number or string of characters used to encrypt, decrypt, or both. One widely used encryption technique is what is commonly known as ‘symmetrical’ encryption, or ‘Private key’ encryption. Both parties share an encryption key, and the encryption key and the decryption key are identical. The key is used by the sender to lock data prior to its transmission, and the recipient requires knowledge of the key to open the message on its receipt. One difficulty is sharing the key, i.e. safely transmitting it to recipient. Generally, for convenience and to help both sender and recipient remember the encryption key, a meaningful number or letter string is used, such as the name of a relative, a famous person or pet, the title of a song or a phone number. This tendency does however somewhat limit the effectiveness of such symmetrical keys, since easily remembered or meaningful keys are more easily broken.

When each communicating pair uses a different key, it is necessary to store the keys in a list or database, which is, itself, a security risk. To overcome the problem of remembering or securing a long list of keys, a group of users, such as all members of a corporation may use the same encryption key. The consequence of grouping users in this manner is that to enable encrypted communication between all group-members, each member is only requires to remember one key. However, grouping users in this manner entails a security risk in that once security is breached all data transfer between all group members is insecure. One threat to data security is gifted computer hackers, but another threat is simply that an individual may simply cease to be a member of the group. If the contract of an employee of a corporation is terminated, for example, to provide adequate protection of data transmission between members of the corporation it may be necessary to change all passwords and encryption keys. This will be critical if such a former employee goes to work for a competitor, for example. Disseminating new encryption keys in a secure manner is itself, not trivial.

Also known, is asymmetrical encryption, otherwise known as ‘public key encryption’. It operates using a combination of two keys: a ‘private key’ and a ‘public key’, which together form a pair of keys.

The sender asks the intended recipient for the public (encryption) key, encrypts the message, and sends the encrypted message to the intended recipient. Only the intended recipient can then decrypt the message—even the original sender cannot read the message to be sent once it is encrypted. The private key is kept secret on the recipient's computer since it is used for decryption, whereas the public key, which is used for encryption, is given to anybody who wants to send encrypted mail to the intended recipient. Thus in public key encryption, only the intended recipient's private key can unlock the message encrypted with the corresponding public key thereof. When a sender wishes to share a secret with an intended recipient using public key encryption, he first asks the intended recipient for his public key. Next, sender uses the intended recipient's public key to encrypt the message. The sender sends message to the intended recipient. The intended recipient uses his private key to decrypt sender's message. Public key encryption works if the intended recipient guards his private key very closely and freely distributes the public key.

The sender's encryption program uses the intended recipient's public key in combination with the sender's private key to encipher the message. When recipient receives Public-Key encrypted mail, he uses his Private Key to decipher it. Decryption of a message enciphered with a public key can only be done with the matching private key. The two keys form a pair, and it is most important to keep the private key safe and to male sure it never gets into the wrong hands, that is, any hands other than those of recipient.

Another crucial point concerning public key encryption is the distribution of the public key. Public key encryption is only safe and secure if the sender of an enciphered message can be sure that the public key used for encryption belongs to the intended recipient. A third party impersonating the intended recipient can produce a public key with the recipient's name and give it to the sender, who uses the key to send important information in encrypted form. The enciphered message is intercepted by the third party, and since it was produced using their public key they have no problem deciphering it with their private key, and in this manner credit card data may be obtained fraudulently, for example. Consequently, it is mandatory that a public key is either personally given to the sender by the recipient, or is authorized by a certificate authority.

Certification of public keys in this manner requires support resources and is costly. Since the private key of a certified asymmetrical encryption key is typically a long string of random digits or letters, it cannot be remembered by user, and it is impractical to type out each time. Consequently, such private keys are stored on their owner's computer. Computer failure, due to viruses or mechanical failure for example, often results in the private key being irretrievably lost. Since the private key is stored on hard disk of recipient, it is far from immune to hackers. Loss of the private key makes encrypted messages unreadable and is both costly and inconvenient to replace.

Nevertheless, most secure email programs use public key encryption. Intended e-mail receivers post their encryption key somewhere accessible, where potential senders can locate it. The sender uses that key to encrypt the message, thus ensuring that only the intended receiver can decrypt it. This works fairly well, but has the disadvantage that one can only send encrypted mail to receivers using a secure email program, and having a posted public key.

Of course, the actual data transmitted need not be encrypted. In SSL (Secure Socket Layer), the data transporter is encrypted. Indeed any of the OSI seven layers may be encrypted.

In general therefore, symmetrical encryption is faster and simpler than and asymmetrical methods. Since certification is not required, symmetrical encryption is also cheaper. Symmetrical encryption is however, typically less reliable and convenient.

Cryptanalysis, or the process of attempting to read the encrypted message without the key, is very much easier with modern computers than it has ever been before. Modern computers are fast enough to allow for ‘brute force’ methods of cryptanalysis—or using every possible key in turn until the ‘plain text’ version of the message is found.

The longer the key, the longer it takes to use the ‘brute force’ method of cryptanalysis—but it also makes the process of encrypting and decrypting the message slower. Key length is very important to the security of the encryption method—but the ‘safe’ key length changes every time CPU manufacturers bring out a new processor.

Because the computational power required for cracking a key increases exponentially with the length of the key, longer keys provide more security. For symmetric keys, 128 bit keys are commonly accepted as secure, for asymmetric, 1024 to 2048 bit. 64 bit symmetric keys take only a couple of hours to crack open by brute force using widely available computing power, and 40 bit asymmetric keys would fall much quicker. With asymmetrical approaches, such as GPG and SSL, because 512/1024/2048 bit keys take heavy toll on systems few people actually encrypt full data using RSA. In SSL and other technologies, only random symmetrical key is encrypted with asymmetrical encryption, and the actual data is encrypted using a symmetrical cipher. Indeed, this is exactly what the public/private key approach was designed for—secure exchange of keys used to encrypt main data.

Yet another popular encryption method called a “hash function,” has been commonly used by Web site operators to scramble online transmissions containing sensitive information such as credit-card information, Social Security numbers and the like. The method, involving an algorithm, generates digital fingerprints, or “hashes,” by performing an equation on a piece of information, switching the order of some bits, cutting down the result to a fixed length and resulting in a fingerprint. Until quite recently, Hash functions were thought to be impenetrable, but it has now been determined that they are not as resistant to hackers as previously thought.

In summary, encryption does not make data absolutely secure. Not using encryption however, means that any data in transit is as easy to read as the contents of a postcard sent in regular mail. Encryption at least ensures that anyone who does read private messages has worked hard at it.

U.S. Pat. No. 5,751,813 to Dorenbos particularly addresses the issue of sending the same message to multiple recipients using individual encryption keys. If the sender has to encrypt the message each time using the public key of a different recipient for the message, the process is troublesome. The encryption and transmission process consumes a lot of time and processing power, and is thus impractical for portable devices, since the sender's terminal equipment may be rendered unavailable for other activities by the user during the encryption and transmission time period. Furthermore, if the user has a portable communication device, such as a laptop computer, the user's battery may run out of power before encryption and transmission of each message has occurred. Dorenbos' solution proposes use of an encryption server for encrypting messages, wherein the encryption server receives a first encrypted message from a sender and decrypts the encrypted message using a first key, yielding a decrypted message comprising (i) a second encrypted message, (ii) an identification of a sender of the first encrypted message, and (iii) an identification of a first recipient. The second encrypted message, the identification of the sender, and the identification of the first recipient are determined from the decrypted message. The second encrypted message and the identification of the sender are then encrypted with a second key, yielding a third encrypted message, and the third encrypted message is transmitted to the intended recipient. Since the public key is only stored on the encryption server and the encryption with recipient's key is performed using the encryption server, sender's resources are not tied up by this encryption process. In this manner, the encryption server encrypts the user's data message individually for each different recipient using that particular recipient's public key. Individual communication units need not store the public keys of all possible recipients, but instead need store only the encryption server's public key. Encryption of the recipient's ID(s) helps to secure the identity of the recipient(s) and eliminates a source of information for traffic analysis by undesired readers/interceptors of such information.

A disadvantage of Dorenbos' solution is that for it to work, of necessity, the so-called encryption server includes a database including a list of sender and recipient identities and the public keys of each identity. Indeed, as pointed out by Dorenbos, for better security, the encryption server should be a physically secured, e.g., locked away with limited access, because unencrypted information is present therein. For communicating between different members of an organization, such as workers of a corporation, this is often convenient. However, particularly when communicating between different corporations, this is not always desirable. Typically corporations know and trust their own server security arrangements, but not those of other corporations, possibly competitors, with whose members, nevertheless, it is necessary, to communicate.

U.S. Pat. No. 5,751,813 to Dorenbos particularly addresses the issue of sending encrypted e-mails to a group, perhaps department members of a large corporation or a management team thereof. As described therein, an encryption server is typically used. The encryption server is typically a server on a node in a network; however the encryption server may be distributed over a plurality of nodes of the network, perhaps for load balancing purposes. Essentially the invention described therein relates to a server on a node of a network that is able to receive encrypted data from a sender, run appropriate decryption procedure, re-encrypt the data again, rerun appropriate encryption procedure for subsequent decryption by intended recipient. The Dorenbos system addresses the issue of a sender using a laptop computer to transmit e-mails to a plurality of recipients using RF transmission, where the computing requirements for encryption seriously drain the computer's resources, particularly the battery thereof. '813 to Dorenbos does not, however, provide a fully secure system. Particularly it will be noted that all senders and recipients using the system have to implicitly trust the security of the encryption server, particularly if symmetrical encryption is used, as is desirable for speed, convenience etc.

Secure e-mail servers, SES, have also been developed by Aliroo in the past, and are described in literature available therefrom. Aliroo's Secure E-mail Servers act as mediators, replacing one encryption key with another, enabling a sender to encrypt with his encryption key, are known in the prior art, and have been described by Aliroo, in the past. One of Aliroo's prior art solutions relies on asymmetrical keys, whereby a sender uses the public key of a server to encrypt his message; the server uses its private key to decrypt same, and re-encrypts the message using the public key of the intended recipient. In consequence, all recipients must have digital certificates and all these digital certificates must be accessible to all servers to enable changing keys as necessary.

As with the system described by '813 to Dorenbos, the e-mail server of this earlier Aliroo technology is required to know the public keys of all potential subscribers, and the server must, therefore, be trusted as being secure by all users thereof. Due to their inherent expense, digital certification is not a practical solution for all members of a large organization. Furthermore by its nature, digital certification limits each user to a specific hardware terminal, and does not allow receiving encrypted e-mail on any networked terminal. In scenarios such as for when sender and recipient of e-mails do not have full confidence in the security of a single encryption server (or a distributed encryption server), both the system and method described in '813 to Dorenbos and the prior art Aliroo solution have been found lacking.

In previous Aliroo patent application WO 2005/099352 to Zorea and Cohen, an earlier application of Aliroo, an alternative approach to the sensitive issue of secure data transmission, was proposed. Essentially, the method of securely sending data from a sender to a recipient over a network described in WO 2005/099352 comprises the steps of:
(a) encrypting the data at terminal equipment of the sender via a first encryption key, thereby producing first encrypted data;
(b) transmitting the first encrypted data from the terminal equipment of the sender to a sender's encryption server;
(c) decrypting the first encrypted data at sender's encryption server using a first decryption key;
(d) identifying recipient's encryption server;
(e) establishing communication between sender's encryption server and recipient's encryption server;
(f) re-encrypting the data using a second encryption key, thereby producing second encrypted data;
(g) transmitting the second encrypted data from the sender's encryption server to the recipient's encryption server;
(h) decrypting the second encrypted data at the recipient's encryption server using a second decryption key;
(i) re-encrypting the data at the recipient's encryption server with a third encryption key thereby producing third encrypted data;
(j) transmitting the third encrypted data to the recipient;
(k) receiving the third encrypted data by the recipient, and
(l) decrypting the third encrypted data with a third decryption key.

Also described therein is a system for transmitting secure data between a sender's terminal equipment and a recipient's terminal equipment over a network, that comprises a sender's encryption server and a recipient's encryption server; each of the encryption servers comprise a data receiver, a decryptor, an encryptor and a transmitter; the sender's encryption server being data connectable to the sender's terminal equipment over a first link of the network and to the recipient's encryption server over a second link of the network; the receiver's recipient's encryption server being further data connectable to the recipient's terminal equipment over a third link of the network.

An inherent disadvantage of the system described in WO 2005/099352, is that the message transmitted between sender and recipient is transmitted via servers and is decrypted and encrypted three times. This itself is a security risk. Particularly it is noted that the sender is required to trust the receiver trusted server to the extent that the sender is willing to transit messages thereto, albeit in encoded form.

The present invention particularly addresses the desire and oft-felt need for a sender to be able to send encrypted message such as encoded e-mails directly to a desired recipient without the data being decoded along the way. Direct transmission of this type requires an exchange of encryption keys between the sender and recipient, such that the encryption key can then be used to encrypt the message to be transmitted. Once the sender has an encryption key and the recipient has the corresponding decryption key, the sender can send one or more encrypted messages.

### SUMMARY OF THE INVENTION

In a first aspect, the present invention is directed to providing a method of facilitating secure sending of a message from a sender to a recipient over a network, comprising the steps of:
(a) establishing communication between a sender side and a recipient trusted server having knowledge of an encryption key of the recipient;
(b) obtaining a messaging key comprising a messaging encryption key and a messaging decryption key;
(c) exchanging messaging key data between the sender side and the recipient trusted server such that sender side has knowledge of the messaging encryption key and the recipient trusted server has knowledge of the messaging decryption key;
(d) encrypting the messaging decryption key with the recipient's encryption key by the recipient trusted server;
(e) transmitting the messaging decryption key encrypted by the recipient's encryption key from the recipient trusted server to the sender side, and
(f) transmitting the messaging decryption key encrypted by recipient's encryption key from the sender side to the recipient and transmitting the message encrypted by the messaging encryption key directly from the sender side to the recipient.

In one embodiment, step (b) of obtaining a messaging key is performed by the sender side and step (c) of exchanging data between the sender side and the recipient trusted server comprises transmitting the messaging decryption key from the sender side to the recipient trusted server.

Typically, step (b) of obtaining a messaging key is selected from the list of creating the messaging key by the sender side and obtaining the messaging key from a third party by the sender side.

In a second embodiment, step (b) of obtaining a messaging key is performed by the recipient trusted server and step (c) of exchanging data between the sender side and the recipient trusted server comprises transmitting the messaging encryption key from the recipient trusted server to the sender side.

Typically, step (b) of obtaining a messaging key is selected from the list of creating the messaging key by the recipient trusted server and obtaining the messaging key from a third party by the recipient trusted server.

Typically the messaging key of step (b) is selected from the list of symmetrical key pairs and asymmetrical key pairs.

Typically the recipient's encryption key is selected from the list of symmetrical key pairs and asymmetrical key pairs.

Optionally, the sender side comprises sender terminal equipment that communicates with the recipient trusted server directly.

Alternatively, the sender side comprises sender terminal equipment and a sender trusted server and the sender trusted server communicates with the recipient trusted server.

Optionally, the sender side and the recipient trusted server are networked in a peer-to-peer manner.

Alternatively, the sender side includes a senders' server and the sender's server and recipient trusted server are part of a hierarchical arrangement of servers, and step (a) of establishing communication between sender's server and recipient trusted server is achieved by each server in said hierarchical arrangement of servers reporting back to servers thereabove regarding identity of accounts held therewith.

In one embodiment, if the sender's server receiving data from the sender does not recognize an intended recipient thereof, said sender's server queries a master server thereabove concerning address of said recipient's trusted server, and so on up hierarchical arrangement until an address of said recipient's trusted server is determined.

The sender side is either located on a single node of the network or is distributed over a plurality of nodes of the network.

The recipient's trusted server comprises either a server on a node of the network, or a plurality of servers distributed over a plurality of nodes of the network.

Typically the network is selected from the list of LANS, WANS, intranets, and Internet.

Typically, the message is an email message.

In a second aspect, the present invention is directed to providing a recipient's trusted server comprising a data receiver, a decryptor, an encryptor and a transmitter for facilitating secure data transmission by the method of:
(i) Establishing communication between a sender side and a recipient trusted server having knowledge of an encryption key of the recipient;
(ii) Obtaining a messaging key comprising a messaging encryption key and a messaging decryption key;
(iii) Exchanging messaging key data between the sender side and the recipient trusted server such that sender side has knowledge of the messaging encryption key and the recipient trusted server has knowledge of the messaging decryption key;
(iv) Encrypting the messaging decryption key with the recipient's encryption key by the recipient trusted server;
(v) Transmitting the messaging decryption key encrypted by the recipient's encryption key from the recipient trusted server to the sender side, and
(vi) Transmitting the messaging decryption key encrypted by recipient's encryption key from the sender side to the recipient and transmitting the message encrypted by the messaging encryption key directly from the sender side to the recipient.

### BRIEF DESCRIPTION OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details; the description taken with the drawings malting apparent to those skilled in the art how the several forms of the invention may be embodied in practice. In the accompanying drawings:

FIG. 1 is a flowchart showing the steps of the method of facilitating secure messaging of the present invention;

FIG. 2 is a schematic block diagram showing the relationship between sender side, recipient and recipient trusted server according to a generalized embodiment;

FIG. 3 diagrammatically illustrates the transfer of data between sender side 14, recipient trusted server 22 and recipient 20 in accordance with the steps of the method of FIG. 1.

FIG. 4 is a schematic block diagram showing the relationship between sender, recipient and recipient trusted server according to one embodiment, where sender contacts recipient trusted server directly, showing the steps of FIG. 1 schematically;

FIG. 5 is a schematic block diagram showing the relationship between sender, recipient and recipient trusted server according to a second embodiment, where sender contacts recipient trusted server indirectly via a server on the sender side, showing the steps of FIG. 1 schematically; and

FIG. 6 is a schematic block diagram showing the relationship between sender, recipient and recipient trusted server according to the second embodiment, where server on the sender side contacts recipient trusted server via a hierarchical structure of servers.

### DETAILED DESCRIPTION OF THE EMBODIMENTS

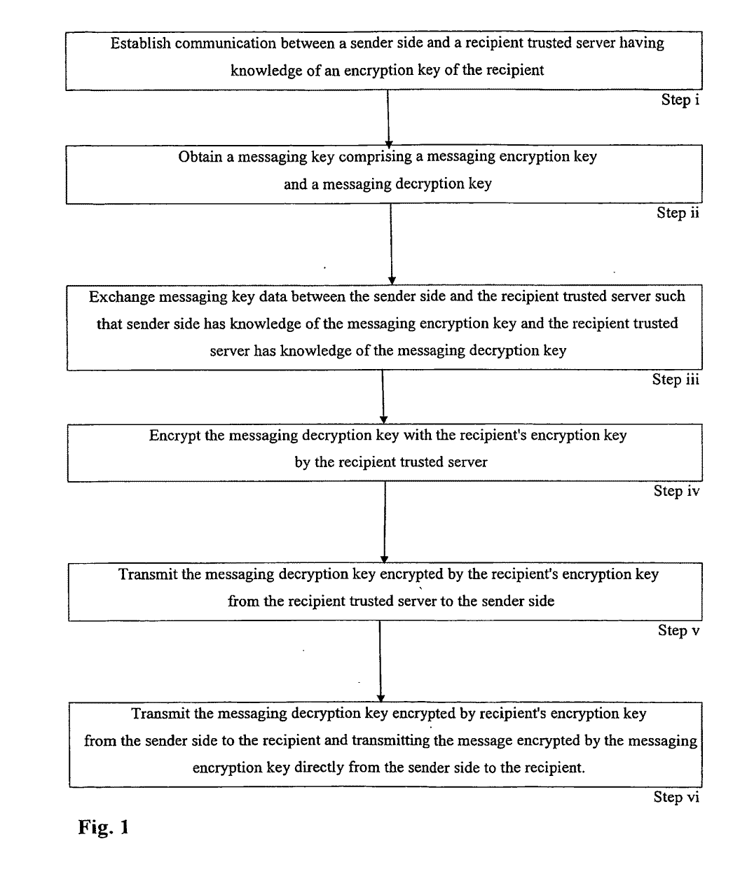

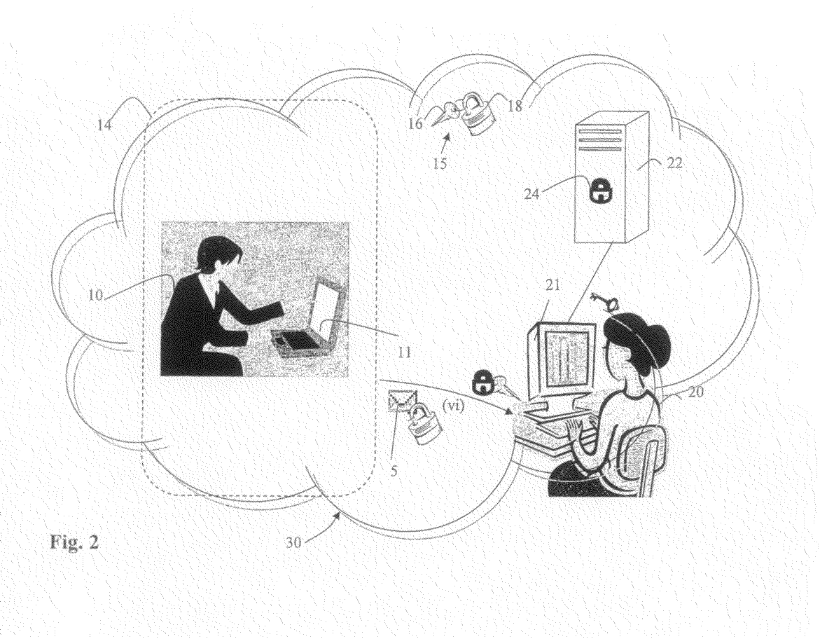

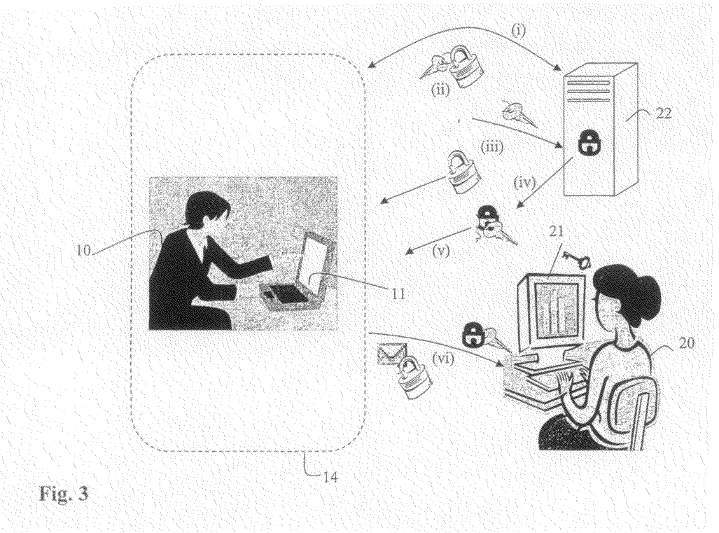

With reference to the flowchart of FIG. 1, the generalized block diagram of FIG. 2, and the figurative data flow shown schematic in FIG. 3, a method of facilitating secure sending of a message 5 from a sender 10 to a recipient 20 over a network 30 is presented. The network 30 is typically the Internet, but could be another type of network, such as a LAN, a WAN, or an intranet, for example.

The method comprising the following steps: establishing communication between a sender side 14 and a recipient trusted server 22 having knowledge of an encryption key 24 of the recipient 20 (Step i); obtaining a messaging key 15 comprising a messaging encryption key 16 and a messaging decryption key 18 (Step ii); exchanging messaging key 15 data between the sender side 14 and the recipient trusted server 22 such that sender side 14 has knowledge of the messaging encryption key 16 and the recipient trusted server 22 has knowledge of the messaging decryption key 18 (step iii); encrypting the messaging decryption key 18 with the recipient's 20 encryption key 24 by the recipient trusted server 22 (step iv); transmitting the messaging decryption key 18 encrypted by the recipient's encryption key 24 from the recipient trusted server 22 to the sender side 14 (step v), and transmitting the message 5 encrypted by the messaging encryption key 16 and the messaging decryption key 18 encrypted with the recipient's encryption key 24 directly from the sender side 14 to the recipient 20 (step vi).

The exchange of the messaging key 15 between the sender side 14 and the recipient server 22 can be achieved in a number of ways. In one embodiment, the sender side 14 obtains the messaging key 15 (step ii), either by the sender side actually creating the messaging key 15 or by obtaining the messaging key from a third party, and transmits the messaging decryption key 18 to the recipient trusted server 22 (step iii).

In a second embodiment, the recipient 20 trusted server 22 obtains the messaging key 15 (step ii) and transmits the messaging encryption key 16 to the sender side 14 (step iii). The messaging key 15 may, once again be created by the recipient trusted server 22 is or obtained from a third party thereby.

The messaging key 15 will typically be a symmetrical key pair created on the fly, but may alternatively be an asymmetrical key pair.

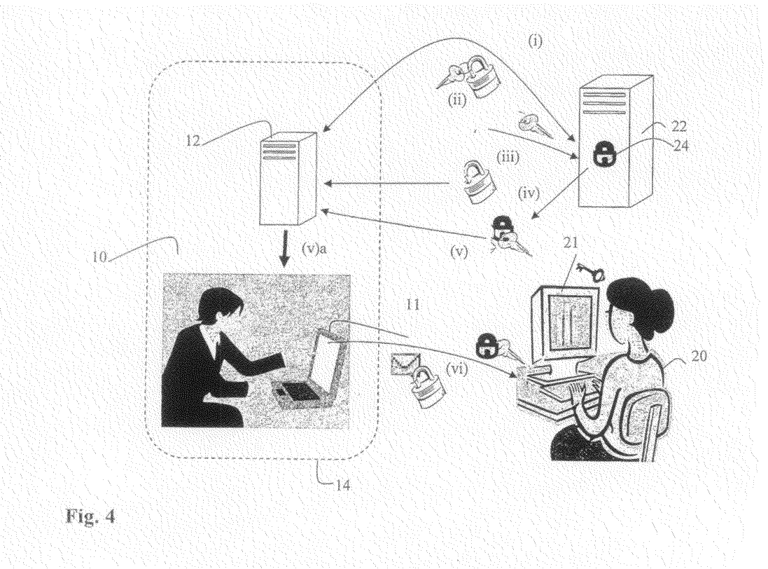

Referring now to FIG. 4, according to one embodiment, step (i) of the method illustrated above with reference to FIG. 1 is accomplished by the sender's 10 terminal equipment 11 communicating with the recipient trusted server 22 directly, the sender side 14 being the sender's terminal equipment 11. The advantage of this setup is that no sender server is required, and the method may be used by individuals, for example. A disadvantage is that the sender's terminal equipment 11 has to perform the encryption, which requires heavy computer resources.

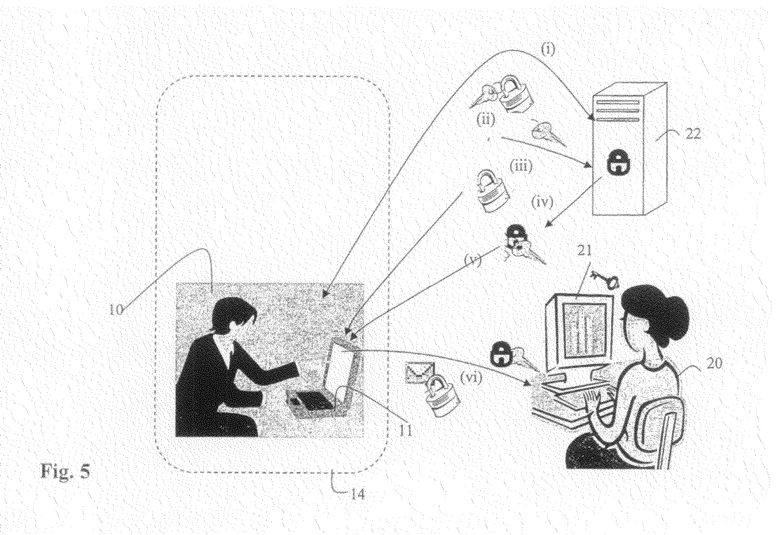

With reference to FIG. 5, in a second embodiment, step (i) of the sender 10 contacting the recipient trusted server 22 is performed indirectly via a server 12 on the sender side 14. The advantage of this setup is that the server terminal equipment 11 does not have to perform the encryption, and thus does not require heavy computer resources. However, a sender server 12 is required. Many corporations have servers 12 and prefer encrypted emails transmitted to outside the corporation to be encrypted centrally for internal security purposes.

In general, the sender side 14 may be located on a single node of the network 30 or may be distributed over a plurality of nodes of the network 30. Similarly, the recipient's trusted server 22 may be either a server on a node of the network 30, or a plurality of servers distributed over a plurality of nodes of the network.

The message 5 may be an email message. Possibly the email account of the recipient 20 is held on a server, which may be supported by the same hardware as the recipient trusted server 22, but it is stressed that conceptually, the recipient 20 and the recipient trusted server 22 are separate entities. The recipient trusted server 22 is trusted by the recipient 20 with the recipient's 20 encryption key 24 and uses the recipient's 20 encryption key 24 to encrypt the messaging decryption key 18. The recipient trusted server 22 does not mediate in the transmission of the message 5 between sender 10 and recipient.

Once the messaging decryption key 18 is transmitted to the recipient 20, further messages may be encrypted with the encryption key 16 of the messaging key 15 and sent from sender 10 to recipient 20. Although optionally, the messaging key 15 is a one time key, a secure messaging means may thus be provided, that can subsequently be reused.

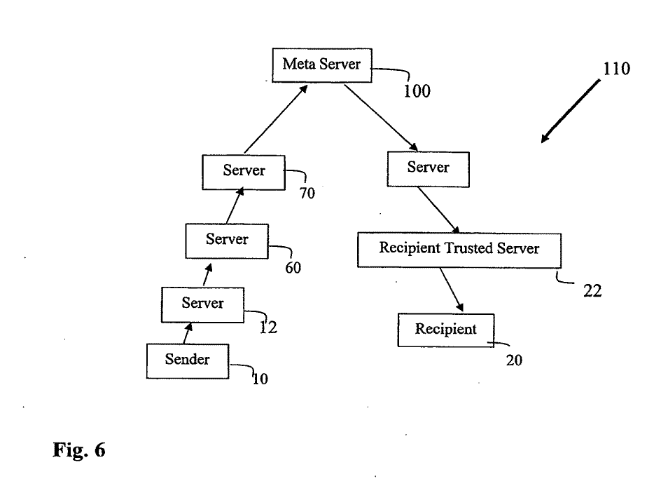

Referring to FIG. 6, one way in which this may be accomplished is for servers to be arranged in a hierarchical structure 110, such that each server reports to a master server, and eventually to a meta-server 100 at the apex of the hierarchical structure 110. Using such an arrangement, where the sender's 10 server 12 does not recognize address of intended recipient 20, sender's 10 server 12 asks its master server 60 whether master server 60 knows with which server the recipient 20 is serviced. Such a query may be transmitted up the hierarchical chain of master servers 60, 70, until either a positive response is received, or the meta-server 100 at the top of the pyramid is reached, which will certainly know where the recipient 20 is registered.

Such a hierarchical server arrangement 110 may operate in a number of ways. For example, in one modus operandi, each server periodically reports identity of users associated therewith up the line, perhaps every hour or so, and also floats the encryption key 24 of the recipient 20 back up the line. The sender 10 server 12 will request knowledge of recipient 20 from master server 60, and then from master server 70, and so on, back up the line. When a server having knowledge of recipient 20 is contacted, (in the example shown in FIG. 6, the meta server 100), the identity of recipient 20 trusted server 22 is passed on to sender 10 trusted server 12, and the messaging key 15 is exchanged between sender side 14 and recipient server 22. Then the encryption key 24 of recipient 20 trusted server 22 is used to encrypt the decryption key 16 of the messaging key 15 and is then transmitted to sender 10 trusted server 12 for sending on to recipient 20.

In addition to symmetrical and asymmetrical encryption, encryption of the message may be achieved using secure SSL or S/MIME encryption, for example. The raw data transmitted may itself be encrypted; the secure socket layer (SSL) or indeed, any of the so-called OSI 7 layers may be encrypted.

Other hierarchical schemes essentially equivalent to the hierarchical server structure described hereinabove will now be apparent to the man of the art. Furthermore, it will be appreciated that the hierarchical structure described hereinabove is merely a preferred method of establishing peer-to-peer communication between sender trusted and user trusted servers. Prior art peer-to-peer communication establishing algorithms may be substituted instead. Indeed a message passed from a sender 10 may be routed via any number of intermediate servers or via a proxy server for example, before reaching the recipient trusted server 22. Additionally, any such intermediate data transfer step may use a unique encryption.

When data communication such as e-mail occurs between users working for different corporations for example, the sender 10 and intended recipient 20 of the e-mail know with which corporation each other works, and the identity of the recipient trusted server 22 is known to the sender 10. In practice many companies use a NAME@entity.com type e-mail address, and it is not known with which server the targeted e-mail account is served. With reference to FIG. 6, this issue may be dealt with by providing a hierarchical server arrangement wherein a plurality of servers are configured in a hierarchical arrangement, such that if a first server receiving data from a sender does not recognize the intended recipient thereof, the first server queries superior servers in said hierarchical arrangement in turn until an address of the recipient 20 is found.

Thus a new approach for safe data transmission is described, particularly for transmitting electronic mail.

Persons skilled in the art will appreciate that the present invention is not limited to what has been particularly shown and described hereinabove. Rather the scope of the present invention is defined by the appended claims and includes combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A method of facilitating secure sending of a message from a sender to a recipient over a network, comprising the steps of:
(i) Establishing communication between a sender side and a recipient trusted server having knowledge of an encryption key of the recipient;
(ii) Obtaining a messaging key comprising a messaging encryption key and a messaging decryption key;
(iii) Exchanging messaging key data between the sender side and the recipient trusted server such that sender side has knowledge of the messaging encryption key and the recipient trusted server has knowledge of the messaging decryption key;
(iv) Encrypting the messaging decryption key with the recipient's encryption key by the recipient trusted server;
(v) Transmitting the messaging decryption key encrypted by the recipient's encryption key from the recipient trusted server to the sender side, and
(vi) Transmitting the messaging decryption key encrypted by recipient's encryption key from the sender side to the recipient and transmitting the message encrypted by the messaging encryption key directly from the sender side to the recipient.

2. The method of claim 1, wherein step (ii) of obtaining a messaging key is performed by the sender side and step (iii) of exchanging data between the sender side and the recipient trusted server comprises transmitting the messaging decryption key from the sender side to the recipient trusted server.

3. The method of claim 2 wherein step (ii) of obtaining a messaging key is selected from the list of creating the messaging key by the sender side and obtaining the messaging key from a third party by the sender side.

4. The method of claim 1 wherein step (ii) of obtaining a messaging key is performed by the recipient trusted server and step (iii) of exchanging data between the sender side and the recipient trusted server comprises transmitting the messaging encryption key from the recipient trusted server to the sender side.

5. The method of claim 4 wherein step (ii) of obtaining a messaging key is selected from the list of creating the messaging key by the recipient trusted server and obtaining the messaging key from a third party by the recipient trusted server.

6. The method of claim 1 wherein the messaging key of step (ii) is selected from the list of symmetrical key pairs and asymmetrical key pairs.

7. The method of claim 1 wherein the recipient's encryption key is selected from the list of symmetrical key pairs and asymmetrical key pairs.

8. The method of claim 1 wherein the sender side comprises sender terminal equipment that communicates with the recipient trusted server directly.

9. The method of claim 1 wherein the sender side comprises sender terminal equipment and a sender trusted server and the sender trusted server communicates with the recipient trusted server.

10. The method of claim 1, wherein the sender side and the recipient trusted server are networked in a peer-to-peer manner.

11. The method of claim 1, wherein the sender side includes a senders' server and the sender's server and recipient trusted server are part of a hierarchical arrangement of servers, and step (i) of establishing communication between sender's server and recipient trusted server is achieved by each server in said hierarchical arrangement of servers reporting back to servers thereabove regarding identity of accounts held therewith.

12. The method of claim 1, wherein if the sender's server receiving data from the sender does not recognize an intended recipient thereof, said sender's server queries a master server thereabove concerning address of said recipient's trusted server, and so on up hierarchical arrangement until an address of said recipient's trusted server is determined.

13. The method of claim 1 wherein the sender side is either located on a single node of the network or is distributed over a plurality of nodes of the network.

14. The method of claim 1, wherein the recipient's trusted server comprises either: a server on a node of the network, or a plurality of servers distributed over a plurality of nodes of the network.

15. The method of claim 1, wherein the network is selected from the list of LANS, WANS, intranets, and Internet.

16. The method of claim 1 wherein the message is an email message.

17. A recipient's trusted server comprising a data receiver, a decryptor, an encryptor and a transmitter for facilitating secure data transmission by the method of claim 1.
